(19) United States
(12) Patent Application Publication
(10) Pub. No.: US 2009/0121476 A1
(43) Pub. Date: May 14, 2009

(54) Microfluidic Bus for Interconnecting Multiple Fluid Conduits

(75) Inventors: Michael P. Malito, Washington, DC (US); Cy R. Tamanaha, Springfield, VA (US); Lloyd J. Whitman, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the US, as represented by the Secretary of the Navy, Washington, DC (US)

(21) Appl. No.: 12/267,177

(22) Filed: Nov. 7, 2008

Related U.S. Application Data
(60) Provisional application No. 60/986,328, filed on Nov. 8, 2007.

(51) Int. Cl. F16L 39/00

(52) U.S. Cl. 285/124.4

(57) ABSTRACT

The present invention relates to a device for interconnecting multiple fluid conduits in a microfluidic environment. The device is typically used to make a low-pressure fluidic connector system for microfluidic applications. A male connector component containing an array of conical nozzles having through holes is connected to fluidic tubing. A female connector component supports an elastomer membrane having an array of receptacles complementary to the nozzles. Through holes through the female connector and membrane are also connected to fluidic tubing. The conical nozzles are aligned with membrane receptacles and a connecting mechanism evenly distributes a compressive force between the male and female components to establish a fluid-tight seal between the nozzles and the membrane.

### CROSS-REFERENCE TO RELATED APPLICATIONS

This Application is a Non-Prov of Prov (35 USC 119(e)) application 60/986,328 filed on Nov. 8, 2007, incorporated in full herein by reference. This application is related to U.S. patent application Ser. No. 11/839,495, filed Aug. 15, 2007, incorporated in full herein by reference.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

A means for quickly connecting and disconnecting tubing and other similar conduits to, from, and between fluidic devices, while maintaining a leak-proof union, has been long sought after, and the list of solutions to this problem are extensive. However, these solutions are optimized for applications with large volumetric flow rates and pressures and are not generally suitable for multi-tube, microfluidic applications. Early examples of other methods to quickly couple fluid carrying single tubes of large bore diameters include Westinghouse, U.S. Pat. No. 116,655, Jul. 4, 1871; Thompson, U.S. Pat. No. 1,019,558, Mar. 5, 1912; Cowles, U.S. Pat. No. 2,265,267, Dec. 9, 1941; Nelson, U.S. Pat. No. 3,430,990, Mar. 4, 1969; and Acker, U.S. Pat. No. 4,191,408, Mar. 4, 1980.

Examples of simultaneous multi-tube connection methods have been disclosed. Many of these methods are also optimized for large volumetric flow rate applications and use complicated multicomponent coupling mechanisms. None of these examples offer the ability to directly integrate the multi-tube fluidic coupling system as part of the microfluidic device. See, for example, Metzger, U.S. Pat. No. 3,381,977 May 7, 1968; Krauer et al, U.S. Pat. No. 3,677,577 Jul. 18, 1972; Hosokawa, et al., U.S. Pat. No. 3,960,393 Jun. 1, 1976; Klotz, et al., U.S. Pat. No. 4,076,279 Feb. 28, 1978; Vyse, et al., U.S. Pat. No. 4,089,549 May 16, 1978; Blenkush, U.S. Pat. No. 4,630,847 Dec. 23, 1986; and Johnston, et. al, U.S. Pat. No. 4,995,646 Feb. 26, 1991.

When scaling-down components for microfluidic applications, fluidic interconnects become of increasing importance because of spatial constraints and size limitations. Examples include methods by Ito, U.S. Pat. No. 5,209,525, May 11, 1993; Gray et al., “Novel interconnection technologies for integrated microfluidic systems,” Sensors and Actuators 77, 57-65 (1999); Kovacs, U.S. Pat. No. 5,890,745, Apr. 6, 1999; Craig, U.S. Pat. No. 5,988,703, Nov. 23, 1999; Benett et al., U.S. Pat. No. 6,209,928, Apr. 3, 2001; Tai et al., U.S. Pat. No. 6,428,053, Aug. 6, 2002; Renzi et al., U.S. Pat. No. 6,832,787, Dec. 21, 2004; Xie et al., U.S. Pat. No. 6,926,989, Aug. 9, 2005; and Knott et al., U.S. Patent Pub. 2006/0032746, Feb. 16, 2006. Most of these solutions require specialized manufacturing methods and complicated or time consuming assembly procedures, and are therefore unsuitable for routine, commercial use.

Commercial apparatus for in-line fluidic connections currently exist. For example, Twintec, Inc, “BC Series Twintec Multiple Tube Disconnect with Integral Push-in Fittings,” Twintec, Inc., available online http://www.twintecinc.com/BC-2002V2.pdf and Colder Products Company, “Multiple Line Products,” available online at http://www.colder.com/Products/tabid/693/Default.aspx?ProductId=23. However, these apparatus all require some form of O-ring seal or retaining ring for each individual tube, requiring the center-to-center spacing of the individual tubing couplers to be many times the tubing diameter. Additionally, no known apparatus have been disclosed that offer the possibility for integration as a seamless component with a microfluidic device. There are commercial components for single tube connections. For example, see Upchurch Scientific, “Lab-On-A-Chip Connections (NanoPort™),” http://www.upchurch.com/. Although these devices are relatively easy to use with little to no dead-volume, the various solutions are either bulky, require carefully cut tubes to ensure a fluid-tight seal, or require special ferrules and nuts to make semi-permanent connections. To alleviate the effects of spatial constraints, fluidic connections are desired without the need, for example, for manual tightening of retaining rings or permanently mounting coupling devices. What would be desirable, therefore, is a simple to manufacture, microfluidic bus for coupling multiple tubes, or conduits, of micron-scale bore size directly from different tubing segments or to microfluidic devices.

### BRIEF SUMMARY OF THE INVENTION

Disclosed is a device for connecting fluid conduits comprising a first component comprising at least one nozzle located on a front side. At least one through hole traverses the component from the nozzle to the back side, and rigid tubing is attached to the through hole at said back side. A second component comprising a support structure configured to support a membrane that is attached to the front side. The membrane comprises at least one receptacle configured to receive the at least one nozzle. The second component further comprises at least one through hole traversing the component from the membrane receptacle to the back side, and rigid tubing is attached to said through hole at said back side. The first and second components are connected so that the nozzle and the receptacle are aligned, and a compressive force is applied to create a fluid-tight seal between the first component and the second component.

### BRIEF DESCRIPTION OF THE DRAWINGS

FIG. 1 is a microfluidic bus showing separated male and female components;

FIG. 2 shows the male component of the microfluidic bus;

FIG. 3 is a microfluidic bus showing connected male and female components;

FIG. 4 shows the female component of the microfluidic bus;

FIG. 5 shows an aluminum mold used to produce an elastomer membrane for the female component;

FIG. 6 shows an embodiment of the microfluidic bus having a male component integrated in a microfluidic cartridge.

FIG. 7 shows an embodiment of the microfluidic bus having a female component integrated into a microfluidic cartridge.

FIG. 8 shows a top view of the male and female components.

### DETAILED DESCRIPTION OF THE INVENTION

A fluidic bus for interconnecting multiple fluid conduits for modular, low-pressure, microfluidic applications is disclosed. As used herein, a microfluidic device is a device with chambers and channels (measured in micrometers, or 0.001 mm to 0.999 mm) for the containment and flow of fluids (measured in nano- and picoliters). Many microfluidic devices require several inlet or outlet lines to allow the passage of fluid to or from the device. The device described here is a standardized system with minimal components that provides the means to quickly connect and disconnect multiple tubes or conduits of micron-scale bore size, ranging from about 100 μm to about 1000 μm, from different tubing segments or from a microfluidic device as a group, in one step, instead of a single tube at a time. In addition, the device can be constructed so that the center-to-center spacing between tubing connectors is as small as two times the inner diameter of the conduit. The apparatus is of particular value for quickly switching between multi-channeled microfluidic devices, whether similar in functionality or not, so long as they all share the same fluidic interface.

The components of this device that enable the quick connection capability include a male part comprising a one-piece array of conical nozzles and a female part comprising an appropriate structure supporting an elastomer membrane containing a complementary array of receptacles for the conical nozzles. Those skilled in the would understand that shapes other than conical may be employed for the nozzles, however the conical nozzle aids in both watertight sealing and self-aligning sealing and is the preferred embodiment. Those skilled in the art would also understand that other materials may be used for complementary array of receptacles for the conical nozzles. For example, a metal to metal fit would have to be manufactured to extremely tight tolerances, i.e. a mirror finish, such that there is no roughness at the metal to metal interface that would allow fluid to penetrate and thus breach the seal. Another option would be a plastic female part, which would be less resilient to wear-and-tear.

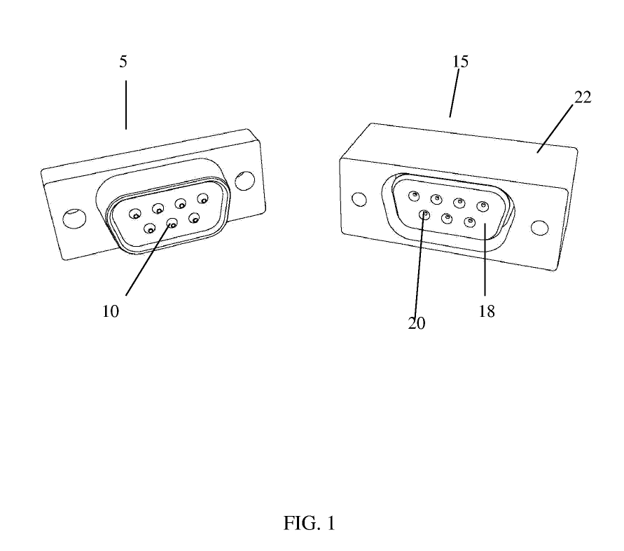

When the supported elastomer membrane receptacle mates with the array of conical nozzles, and a compressive force is applied, a fluid-tight seal is formed between the membrane and nozzle array. In principle, there is no limit to the number of conical nozzles, and matching receptacles, that can be constructed. Ultimately this will be dictated by either the number of tubes required, spatial constraints of the microfluidic device, or the ability to provide an even pressure across the mating parts to maintain the fluid-tight seal. FIG. 1 shows the microfluidic bus for interconnecting multiple fluid conduits with the male and female parts disconnected. This embodiment is an inline embodiment of the device. The male part 5 comprises a one-piece array of conical nozzles 10. The female part 15 comprises an elastomer membrane 18 containing a complementary array of receptacles 20 for the conical nozzles 10. The elastomer membrane 18 is supported by a support structure 22.

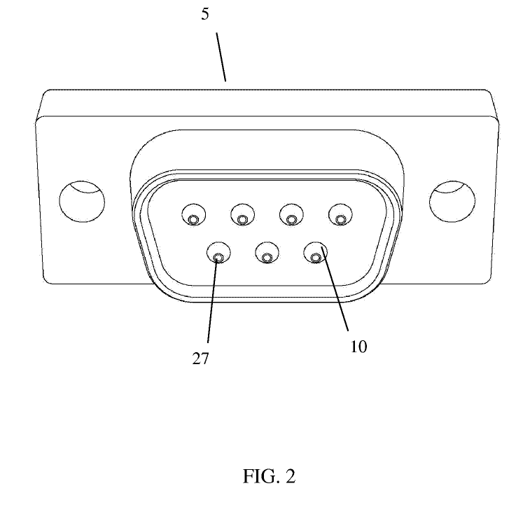

The manufacturing method described here comprises a four main components to produce the fluidic connector apparatus. As shown in FIG. 2, a male connector 5 containing an array of conical nozzles 10 having matching through-holes 27 is provided. FIG. 1 shows the solid substrate support 22 for the female connector component 15 having at least one elastomer membrane 18 having an array of complementary receptacles 20 configured to receive the conical nozzles 10. Also provided is a means to compress the male and female connectors together, such as thumb screws. Those skilled in the art would understand that any means to provide a compression force would also work, such as clips, fasteners, clasps, bolts and the like.

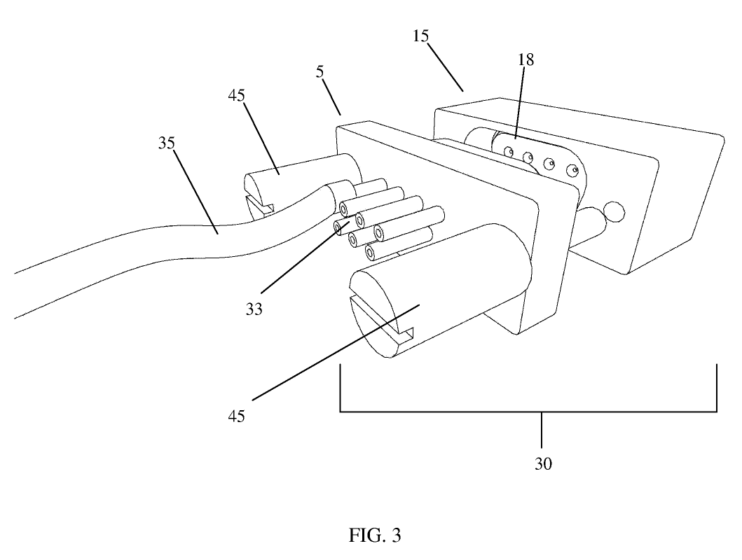

Typically, machining produces a monocoque, i.e., single-unit construction, structure for the male connector. The overall connector system may be designed in a CAD program that meets the mounting requirements of the microfluidic device. The manufacturing procedure can then be programmed in G-code for CNC milling. The male component may be precision milled from a single stock of hard material such as metal or plastic. In one embodiment, an array of through-holes are first drilled in the starting material in a predetermined pattern required to conveniently organize the attachment of the tube bundle. Then, using a milling tool with an acute pitch, an array of cones are milled out such that a protruding cone circumscribes each of the drilled through-holes. FIG. 2 shows the male component 5 with array of milled out conical nozzles 10 circumscribing each through-hole 27. The pitch of the milling tool used in the example was 60°, but the precise angle is not important as long as it is conical and allows the desired center-to-center spacing. Typically, the angle ranges from about 45° to about 60°. Those skilled in the art would understand that the center-to-center spacing depends, ultimately, on how small a diameter the manufacturer can make the milling tool. FIG. 3 shows short lengths of hard, rigid tubing 33 are permanently glued or otherwise attached to the through holes 27 on the side of the male component 5 opposite of the cone array. Those skilled in the art would understand that other kinds of tubing or connections can be used. For example, the tubing used in one embodiment was comprised of polyetheretherketone (PEEK). Additionally, hypodermic stainless-steel tubing could be used or a single unit construction (monocoque) can be done on a milling machine. At least one individual fluidic tube 35 is slipped over the rigid tubing 33 to complete the attachment of a tube bundle (not shown) to the male fluid connector 5. FIG. 3 shows a in-line microfluidic bus assembly 30, having inlet/outlet tubing 35 attached to the male 5 component of the in-line microfluidic bus. Those skilled in the art would understand the direction of fluidic flow would be a design choice, thus the inlet and outlet tubing designation will be determined by that design. Thumbscrews 45 were used to compress the male component 5 and the female component 15 of the in-line microfluidic bus together to make a fluid-tight seal between the conical nozzles (not shown) and the elastomer membrane 18.

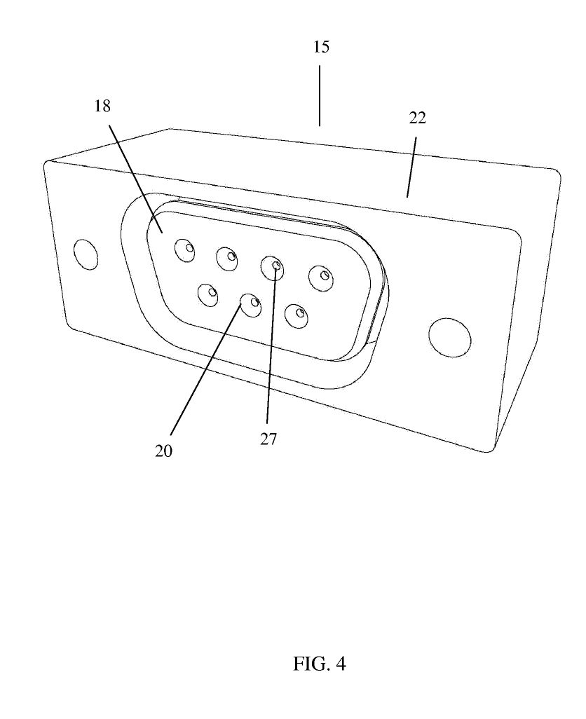

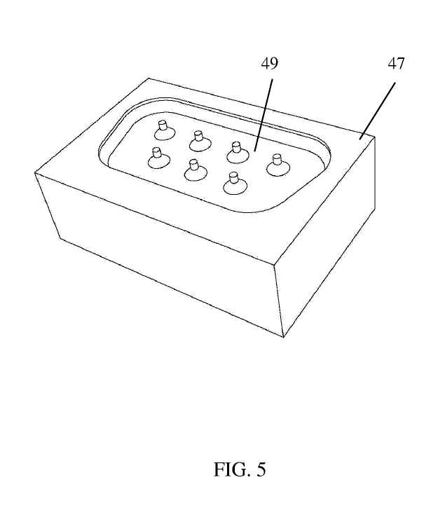

The elastomer membrane of the female component with its array of receptacles is produced from a mold, such as the aluminum mold 47 shown in FIG. 5. The inverse image of the membrane 49 may be made by CNC machining from a block of aluminum. FIG. 4 shows the female component 15 having a supporting structure 22 containing an elastomer membrane 18 with an array of receptacles 20. Each receptacle 20 has a conical indentation ending in a through-hole 27 that corresponds to the conical nozzles of the male component. This design reduces the possibility of wear from the sharp edges of the conical nozzles. A liquid pre-polymer of a suitable membrane material such as urethane rubber (Smooth-On VytaFlex® 40) is poured into the mold and allowed to cure per manufacturer's instruction. Once solidified, the membrane is removed from the mold and is then mounted, typically with double-sided acrylic tape, to a supporting solid substrate that has through holes drilled through it that line-up with the array of receptacles. FIG. 3 shows the short lengths of hard, rigid tubing 33 are permanently attached, for example, glued, into the appropriate through holes in the solid substrate support on the side opposite of the membrane. Individual fluidic tubes 35 are slipped over the rigid tubing 33 to complete the attachment of a tube bundle to the female fluid component 15.

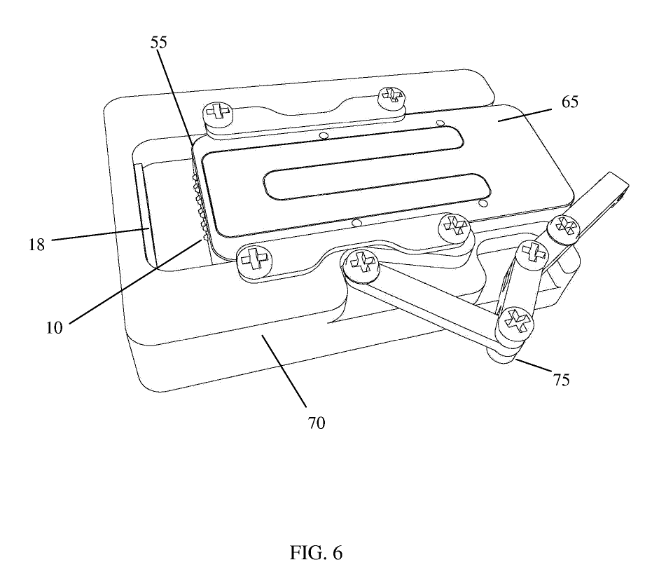

One embodiment of the present device is directed to related patent application U.S. patent application Ser. No. 11/839,495, incorporated in full herein by reference, for a method and apparatus for attaching a fluid cell to a planar substrate. In one embodiment of that application, a multi-integrated fluid cell platform for parallel assay experiments performed under a microscope is described whereby fluidic connections to the cells are provided by microchannel extensions milled into the support body. FIG. 6 shows a microfluidic bus device that provides a means for getting fluids into the microchannel extensions. The multi-integrated fluid cell platform (microfluidics cartridge) 65 is configured with the male component of the microfluidic bus containing an array of conical nozzles 10, preferably located on one edge 55 of the support body (fluidic cartridge) 65. The cartridge 65 is then inserted into a docking station 70 that contains the female component and the elastomer membrane 18 with the array of matching receptacles configured for receiving the conical nozzles 10 of the male component. Inlet and outlet tubing are attached to the appropriate holes of the docking station. A fluid-tight seal is formed by compressing the cartridge edge 55 with the nozzle array 10 against the membrane 18 by mechanical means, such as a spring-loaded articulated lever system 75. Those skilled in the art will recognize that although the multi-integrated fluid cell platform is used here as an example “microfluidic device,” this invention is well suited to other microfluidic devices including, but not limited to, fluidic “cubes” and sensor “tickets,” or in hybrid systems in which fluidics are integrated with electronic circuit boards.

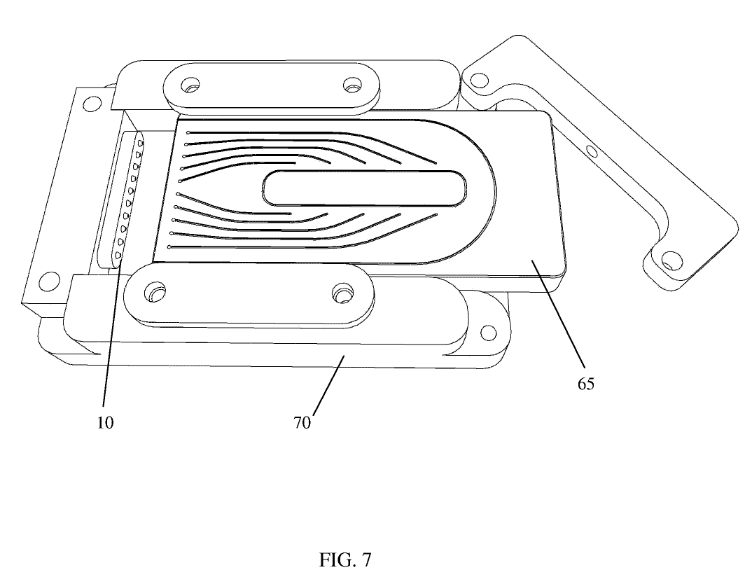

A second embodiment is simply the reversal of the mating components on the microfluidic apparatus mentioned in the above embodiment. FIG. 7 shows the conical nozzles 10 are part of the docking station 70, and the elastomer membrane (not shown) with the array of matching receptacles for the conical nozzles 10 are integrated with the cartridge 65. The decision on whether the male or female connector is integrated into the microfluidic device will depend on manufacturing capabilities and materials and/or end-use objectives (e.g. disposable, reusable, ruggedness etc.) for that device.

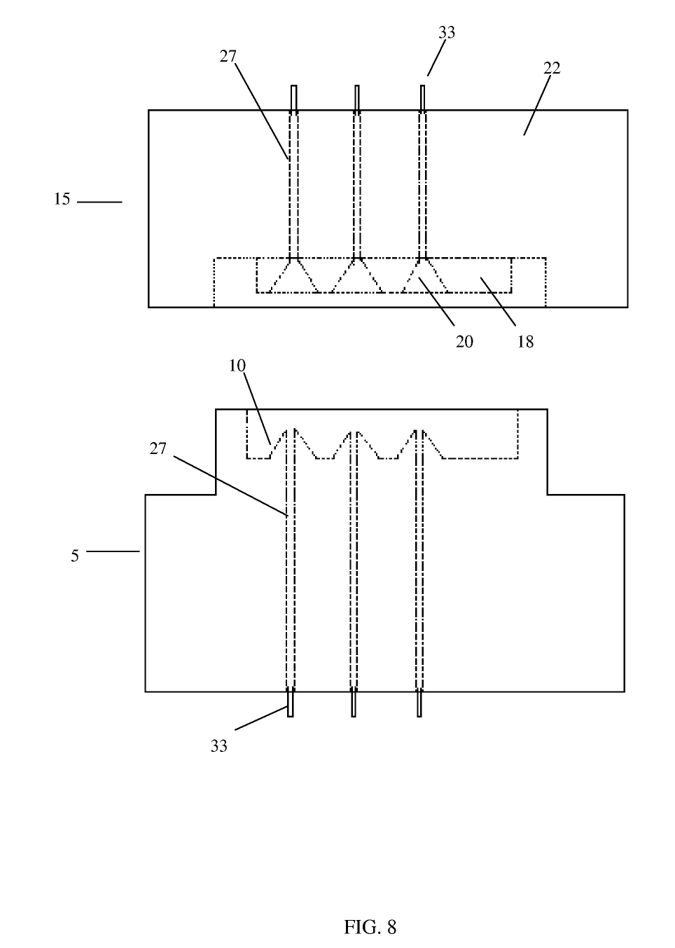

A third embodiment is an autonomous pair of male and female connectors from which tubing bundles have been attached. In one usage scenario, the free ends of each tubing bundle can be permanently attached to separate fluidic devices. The quick, in-line, fluidic connection between both fluidic devices is accomplished by mating the connector pair, as shown in FIGS. 1-4. FIG. 8 shows a top down perspective of autonomous pair of male and female connectors. The female connector 15 is comprised of a supporting structure 22 having through holes 27. The supporting structure 22 supports an elastomer membrane 18 having receptacles 20 configured to receive the conical nozzle 10 of the male connector 5. The through holes 27 continue through the membrane 18 and are connected to rigid tubing 33 on the opposite side of the supporting structure 22 from the elastomer membrane 18. The male connector 5 has through holes 27 traversing the male connector 5 from the conical nozzles 10 to the side opposite the conical nozzles, where rigid tubing 33 is connected to the through holes 27.

For those familiar in the arts of microfluidics and fluidic interconnections, this invention has several advantages and new features not currently available for modular, relatively low-pressure, microfluidic systems. This device requires only four different components to make a low-pressure fluidic connector system for microfluidic applications: a) a monocoque male connector component containing an array of conical nozzles, b) a solid substrate support for the female connector component in addition to, c) a single membrane with an array of nozzle receptacles supported by the solid substrate, and d) a mechanism to evenly distribute a compressive force between the two connectors to establish a fluid-tight seal between all nozzles and the membrane. The uniquely simple design of the male and female connectors is scalable such that more sophisticated manufacturing techniques such as micromachined silicon, embossed thermoplastic, injection molded plastic, or laser ablation are possible. The method is suited to manufacturing both reusable and disposable devices. The device permits design modularity by allowing quick, convenient, and easy attachment/detachment of multiple microfluidic devices. This is an especially useful feature when running high-throughput tests or assays on multiple microfluidic cartridges or similar devices. The technology is fully expandable to a number of fields where microfluidic devices are used including small scale biochemical analysis, bioreactors, chemical, electrochemical, pharmacological and biological applications.

Although this device establishes manufacturing methods within reach of the capabilities of a typical laboratory facility, there is no reason such methods could not be replaced by more sophisticated procedures such as LIGA and related MEMS manufacturing technology to produce systems with sub-millimeter dimensions in materials other than plastics (e.g. silicon, aluminum, etc.). Attaching the tubing bundles to the connectors is not limited to slipping the tubes over shorter lengths of hard, rigid tubing permanently glued into the connectors. One could apply the same manufacturing methods used to make the cone shaped nozzle array to also produce the shorter tubing as part of the monocoque structure of the connectors. One could also use commercial single tube ferrules or ports as well. Finally, the manufacturing method of using CNC milling could also be injection molded using thermoplastics for mass production of an integrated fluidic connector system. While the disclosure demonstrated these apparatus with fluids, they could also be used for low-pressure or low-vacuum gas interconnections.

What is claimed as new and desired to be protected by Letters Patent of the United States is:

1. A device for connecting fluid conduits comprising:
a first component comprising a front side and a back side, at least one nozzle located on the front side, at least one through hole traversing the component from the at least one nozzle to the back side, and rigid tubing attached to said through hole at said back side;
a second component comprising a front side and a back side, wherein the front side is configured to support a membrane attached to the front side, wherein the membrane comprises at least one receptacle configured to receive the at least one nozzle at least one through hole traversing the component from the receptacle to the back side, and rigid tubing attached to said through hole at said back side; and
means for applying a compressive force between the first component and the second component wherein the nozzle of the first component is aligned with the receptacle of the second component.

2. The device of claim 1 wherein said nozzle is a conical nozzle.

3. The device of claim 1 wherein said membrane is comprised of an elastomeric material.

4. The device of claim 1 wherein said means for connecting is selected from group consisting of screws, clips, fasteners, clasps, or bolts.

5. The device of claim 1 wherein said through holes range from about 100 μm to about 1000 μm in bore size.

6. The device of claim 1 wherein said first and second components are integrated into a microfluidic bus and microfluidic cartridge of a fluidic cell platform.

7. A device for connecting fluid conduits comprising:
a first component comprising a front side and a back side, at least one nozzle located on the front side, at least one through hole traversing the component from the at least one nozzle to the back side, and rigid tubing integrated into said first component in connection with the through hole at said back side;
a second component comprising a front side and a back side, wherein the front side is configured to support a membrane attached to the front side, wherein the membrane comprises at least one receptacle configured to receive the at least one nozzle at least one through hole traversing the component from the receptacle to the back side, and rigid tubing integrated into the second component in connection with the through hole at said back side; and
means for applying a compressive force between the first component and the second component wherein the nozzle of the first component is aligned with the receptacle of the second component.

8. The device of claim 7 wherein said nozzle is a conical nozzle.

9. The device of claim 7 wherein said membrane is comprised of an elastomeric material.

10. The device of claim 7 wherein said means for connecting is selected from group consisting of screws, clips, fasteners, clasps, or bolts.

11. The device of claim 7 wherein said through holes range from about 100 μm to about 1000 μm in bore size.

12. The device of claim 1 wherein said first and second components are integrated into a microfluidic bus and microfluidic cartridge of a fluidic cell platform.
